(19) United States
(12) Patent Application Publication
(10) Pub. No.: US 2011/0139689 A1
(43) Pub. Date: Jun. 16, 2011

(54) Monitoring A Preparative Chromatography Column From the Exterior During Formation of the Packed Bed

(75) Inventor: Mark A. Snyder, Oakland, CA (US)

(73) Assignee: BIO-RAD LABORATORIES, INC., Hercules, CA (US)

(21) Appl. No.: 12/797,986

(22) Filed: Jun. 10, 2010

Related U.S. Application Data
(60) Provisional application No. 61/221,926, filed on Jun. 30, 2009.

(51) Int. Cl. B01D 35/14; B30B 9/00; F17D 1/00

(52) U.S. Cl. 210/95; 100/35; 137/1

(57) ABSTRACT

In an axial-flow cylindrical preparative chromatography column that utilizes a piston to close off the top of the resin space inside the column and thereby eliminate void spaces at the top of the resin, a sight glass is incorporated in the column wall to allow monitoring of the packing height and density as the packing material is being placed inside the column, as well as the position of the piston head relative to the packing while the piston is being lowered to consolidated and/or compress the packing. By observing the column interior through the sight glass, the operator can assure that the column receives a more uniform packing density and can minimize the risk of damage to the packing material by excessive force from the piston head.

### CROSS-REFERENCE TO RELATED APPLICATION

This application claims the benefit of U.S. Provisional Patent Application No. 61/221,926, filed Jun. 30, 2010, the contents of which are incorporated herein by reference.

### BACKGROUND OF THE INVENTION

1. Field of the Invention

This invention resides in the field of preparative chromatography columns.

2. Description of the Prior Art

Preparative chromatography is a separation technique used to extract individual chemical species from mixtures of species for purposes of obtaining the individual species in sufficient quantity and purity to be used for therapeutic or other procedures. Preparative chromatography thus differs from analytical chromatography whose purpose is simply to determine the presence or concentration of particular components in the mixture or to determine the composition of the entire mixture. Preparative chromatography is used, for example, for purifying monoclonal antibodies and other proteins, as well as for purifying vaccines and any variety of peptides. Preparative chromatography is commonly performed by passing the source mixture through a packed column that will bind the species of interest, then eluting the bound species column with an elution buffer once all of the other components in the source mixture have passed through the column or have been washed out of the column with a wash buffer. The binding of the species of interest is achieved by any of a variety of interactions between the mobile phase (which includes the source mixture) and the stationary phase (the column packing). Examples of these interactions are ion-exchange chromatography, affinity chromatography, and liquid-liquid or partition chromatography.

Flow through a preparative chromatography column is generally in the axial direction, and the axial length of the column must be limited in order to avoid an excessive pressure drop through the column, since high pressure drops require a high mobile phase pump pressure, high power to drive the pump, or both. With columns of limited depth, however, the extraction of the species of interest at a rate that is commercially useful requires a column of large diameter. The typical preparative column thus has a diameter of at least several centimeters, and in some cases, a meter or more. Columns of large diameter present certain challenges, however, one of which is the difficulty in distributing the flow effectively across the width of the column. A uniform flow distribution is needed for good separation and resolving power and for maximal use of the column packing, and the larger the diameter the more difficult these are to achieve. Flow distributors are typically used at both ends of the column to address this problem. Another challenge, which arises particularly in columns that are arranged vertically with downward flow, is the difficulty of packing the column in a manner that produces a uniform packing density in the column. A poorly packed bed will contain void spaces that cause flow channeling which can likewise reduce the contact between the mobile and stationary phases and thereby reduce the resolving power. Void spaces can be eliminated by applying pressure to the packing, and a sliding piston, also referred to as an “adaptor,” which also contains flow distribution channels, is commonly used for this purpose. A piston applying high pressure to the packing, however, can lead to fracture or pulverization of portions of the packing material, particularly if the material is incompressible or fragile. The lowering of the adaptor must therefore be closely controlled to avoid such damage. Additionally, for those resins where packing is controlled by compressing the resin to a prescribed degree relative to its uncompressed state, the total amount of resin in the column, and hence the resin height, prior to compression must be known.

### SUMMARY OF THE INVENTION

The present invention resides in a preparative chromatography column whose wall includes a strip of transparent material that functions as a sight glass through which the height, the density, or both, of the column packing can be monitored as the column is being loaded with the packing material. The transparent strip can also allow the position of the adaptor to be monitored as the adaptor is being lowered onto the packing. While the major portion of the column wall is typically constructed of steel or other opaque material, the monitoring strip is transparent to allow monitoring to be performed through the column wall from the exterior of the column.

These and other objects, features, and advantages of the invention will be apparent from the description that follows.

### BRIEF DESCRIPTION OF THE DRAWINGS

FIG. 1 is a perspective view of a preparative chromatography column in accordance with the present invention.

FIG. 2 is a cross section of the preparative chromatography column of FIG. 1

### DETAILED DESCRIPTION OF THE INVENTION AND PREFERRED EMBODIMENTS

The strip of column wall occupied by the transparent material will at least have a component that is parallel to the longitudinal axis of the column. The strip can thus itself be parallel to the axis or it can be a spiral or otherwise angled with a tangential component and an axial component. For purposes of simplicity, a strip that is itself parallel to the column axis is preferred. The length of the strip in the axial direction can be equal to or less than the length of the column, provided that it has an axial length and position that brackets the range of bed heights that may be used in the column and that allows observation or detection of the adaptor position as it the adaptor approaches the bed.

Any transparent material that is rigid, that can withstand the column pressure, and that is inert to all liquids and other materials that will occupy the column, including biological fluids, wash buffers, and elution buffers, can be used for the monitoring strip. Preferred transparent materials are those that are also resistant to etching and other surface degradations that might reduce visibility. Examples of suitable materials are transparent polymers such as acrylic, polycarbonate, a styrenic polymer, a polyester, or a polyimide. Further examples are glass such as borosilicate glass, soda lime glass, lead glass, fused quartz, diamond, or sapphire. The strip can be plain or can have markings to indicate the height of the visualized packing or of the adaptor above the column floor.

The transparent strip is preferably mounted in the column wall in such a manner that the strip is sealed along its edges to prevent leakage around the strip of any fluids from the column interior. The strip is also preferably shaped and mounted in such a manner that the inner surface of the strip does not interfere with, or otherwise influence, either the distribution of packing material in the column or the flow of liquid through the column. The column itself is a cylinder, which term is used herein according to its dictionary definition to mean the surface created by a straight line moving parallel to a fixed straight line and intersecting a fixed planar closed curve. A right circular cylinder is one in which the closed curve is a circle and the fixed straight line is the axis of the circle or any line that is perpendicular to the plane of the circle. Thus, for a column that is a right circular cylinder, the inward-facing surface of the strip is preferably of a concave curvature to match that of the inner wall surface of the column.

Securement of the strip to the remainder of the column wall can be achieved by conventional means, although a preferred means is by providing the strip with a cross section in the form of a truncated wedge so that pressure from the column interior will force the edges of the strip against the contacting edges of the adjacent column wall to enhance the seal. Gasket materials can also be placed between the contacting edges to further enforce the seal. To compensate for any lessening of the column's structural integrity due to the inclusion of the transparent strip, a reinforcing flange or band can be placed around the outer surface of the column wall.

Monitoring of the column packing through the strip of transparent material can be performed by instrumentation, including machine detection, automated illumination and the detection of reflected or non-absorbed light, or by visual observation. Monitoring by visual observation is preferred.

The attached figures offer views of an example of a preparative chromatography column incorporating the features of the present invention.

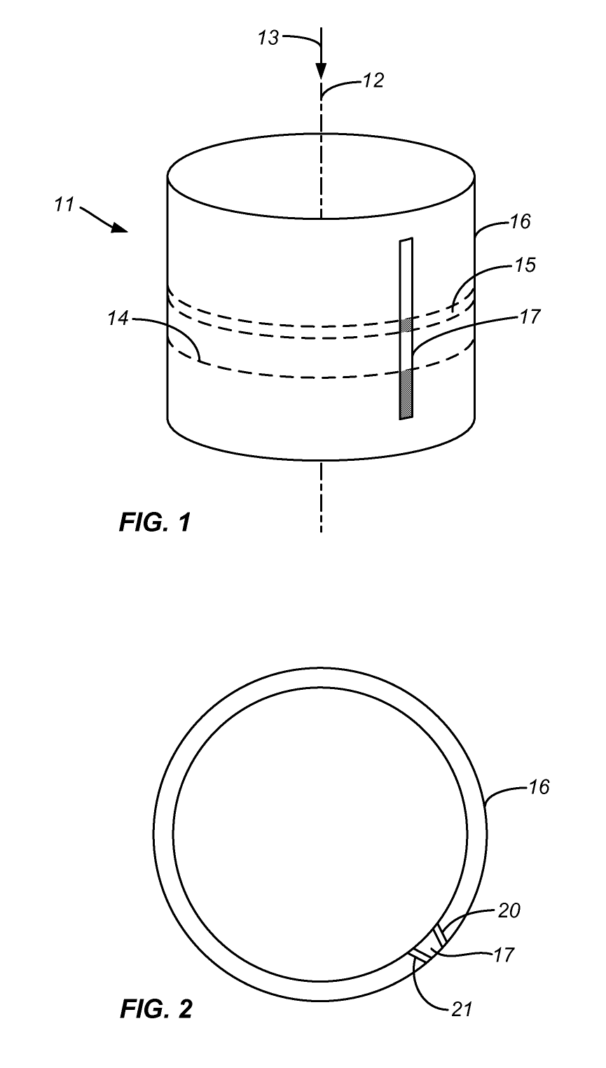

FIG. 1 is a perspective view of the column 11, showing that the column is a right circular cylinder with a cylinder axis 12. The direction of flow of the source mixture, wash buffer(s), and elution buffer through the column is indicated by the arrow 13 which is parallel to the column axis 12. The column packing is placed in the column from above through the upper end of the column, and the height of the packing in the column interior is indicated by the dashed line 14. The adaptor 15 is also indicated by dashed lines. The column wall 16 is stainless steel except for the glass (or other transparent material) strip 17, and both the packed bed and the adaptor are visible through the transparent strip.

FIG. 2 is a cross section of the column wall taken at mid height. The stainless steel portion 16 forms almost the entire circumference of the column wall, and the glass strip 17 occupies the remainder of the circumference. The longitudinal edges of the glass strip are not parallel but instead are angled to form a wedge, as are the edges of the adjacent steel, so that an internal column pressure that is higher than the external pressure will press the glass strip against the steel without danger that the strip will be forced out of the wall. The glass strip can be wrapped with a flat gasket material, or, as shown in the example shown in the Figure, strips 20, 21 of gasket material can be placed between the glass and the stainless steel, to further enforce the seal.

Numerous variations on the structure and configuration shown in the Figures that are still within the scope of the invention will be apparent to those skilled in the chromatography art. For example, the column wall can contain two or more transparent strips positioned at different locations around the column circumference. Other examples will be readily apparent.

In the claims appended hereto, the term “a” or “an” is intended to mean “one or more.” The term “comprise” and variations thereof such as “comprises” and “comprising,” when preceding the recitation of a step or an element, are intended to mean that the addition of further steps or elements is optional and not excluded. All patents, patent applications, and published reference materials in general that are cited in this specification or added thereto subsequent to filing are incorporated herein by reference in their entirety. Any discrepancy between any reference material cited herein and an explicit teaching of this specification is intended to be resolved in favor of the teaching in this specification. This includes any discrepancy between an art-understood definition of a word or phrase and a definition explicitly provided in this specification of the same word or phrase.

What is claimed is:

1. In a preparative chromatography column comprising a hollow cylindrical body having a longitudinal axis and a piston disposed in said cylindrical body and movable along said axis to define an upper end of a resin space in said cylindrical body, the improvement wherein a strip section of said cylindrical body having a component parallel to said axis is replaced by a strip of transparent material to allow monitoring of the interior of said column through said transparent material during placement of particulate chromatographic resin in the column and during lowering of said piston over said resin.

2. The preparative chromatography column of claim 1 wherein said strip section is parallel to said axis.

3. The preparative chromatography column of claim 1 wherein said cylindrical body is a right circular cylinder with a concave inner surface and said strip section has an inward-facing surface that is concave to form a continuous curve with said concave inner surface of said cylindrical body.

4. The preparative chromatography column of claim 3 wherein said strip section is parallel to said axis and said strip of transparent material has longitudinal edges angled to form a wedge.

5. A method for forming a bed of chromatographic resin particles in a cylindrical preparative chromatography column having a longitudinal axis and a piston movable within said column along said axis to define an upper end of a resin space in said column, said method comprising feeding a slurry of said particles to said column to form a bed of said particles within said column while monitoring said bed thus formed through a transparent strip of wall of said column, said transparent strip having a component parallel to said axis.

6. The method of claim 5 wherein said strip section is parallel to said axis.

7. The method of claim 5 wherein said cylindrical body is a right circular cylinder with a concave inner surface and said strip section has an inward-facing surface that is concave to form a continuous curve with said concave inner surface of said cylindrical body.

8. The method of claim 5 wherein said monitoring is performed by visual observation.

9. A method for lowering a piston over a bed of chromatographic resin particles within a cylindrical preparative chromatography column having a longitudinal axis to enhance uniformity of packing density of said bed substantially without fracturing said particles, said method comprising monitoring the position of said piston inside said column through a transparent strip of wall of said column, said transparent strip having a component parallel to said axis, as said piston comes into contact with said particles.

10. The method of claim 9 wherein said monitoring is performed by visual observation.

11. The method of claim 9 wherein said strip section is parallel to said axis.

12. The method of claim 9 wherein said cylindrical body is a right circular cylinder with a concave inner surface and said strip section has an inward-facing surface that is concave to form a continuous curve with said concave inner surface of said cylindrical body.
